(19) United States
(12) Patent Application Publication
(10) Pub. No.: US 2013/0094529 A1
(43) Pub. Date: Apr. 18, 2013

(54) LASER APPARATUS, METHOD FOR GENERATING LASER BEAM, AND EXTREME ULTRAVIOLET LIGHT GENERATION SYSTEM

(71) Applicant: Osamu Wakabayashi, Hiratsuka-shi (JP)

(72) Inventor: Osamu Wakabayashi, Hiratsuka-shi (JP)

(73) Assignee: GIGAPHOTON INC., Oyama-shi, Tochigi (JP)

(21) Appl. No.: 13/805,264

(22) PCT Filed: Mar. 8, 2012
(86) PCT No.: PCT/IB2012/000443

§ 371 Date: Dec. 18, 2012

(30) Foreign Application Priority Data
Mar. 29, 2011 (JP) 2011-073468
Jan. 17, 2012 (JP) 2012-007210

(51) Int. Cl. H01S 3/10

(52) U.S. Cl. CPC H01S 3/10007
USPC 372/27

(57) ABSTRACT

A laser apparatus for generating extreme ultraviolet (EUV) light at a wavelength of approximately 13 nm is provided. The laser apparatus may be combined with a reduced projection reflective optical system. Systems and methods for generating EUV light are also provided.

### CROSS-REFERENCE TO RELATED APPLICATIONS

The present application claims priority from Japanese Patent Application No. 2011-073468 filed Mar. 29, 2011, and Japanese Patent Application No. 2012-007210 filed Jan. 17, 2012.

### BACKGROUND

1. Technical Field

This disclosure relates to a laser apparatus, a method for generating a laser beam, and an extreme ultraviolet light generation system.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication at 32 nm or less, for example, an exposure apparatus is expected to be developed, in which an apparatus for generating extreme ultraviolet (EUV) light at a wavelength of approximately 13 nm is combined with a reduced projection reflective optical system.

Three kinds of systems for generating EUV light are generally known, which include a Laser Produced Plasma (LPP) type system in which plasma is generated by irradiating a target material by a laser beam, a Discharge Produced Plasma (DPP) type system in which plasma is generated by an electric discharge, and a Synchrotron Radiation (SR) type system in which orbital radiation is used.

### SUMMARY

A laser apparatus according to one aspect of this disclosure may include: a plurality of master oscillators each configured to output a pulse laser beam at a different wavelength; at least one amplifier for amplifying the pulse laser beams; an optical shutter provided in a beam path of at least one of the pulse laser beams, the optical shutter being configured to adjust a transmittance of a pulse laser beam passing therethrough in accordance with a voltage applied thereto; a power source for applying the voltage to the optical shutter; a beam path adjusting unit provided in a beam path between the optical shutter and the amplifier for making beam paths of the pulse laser beams coincide with one another; and a controller configured to control the voltage to be applied to the optical shutter by the power source on a pulse-to-pulse basis for the pulse laser beam.

A method according to another aspect of this disclosure for generating a laser beam in a laser apparatus that includes an amplifier containing a laser gas as a gain medium, at least two master oscillators each configured to output a pulse laser beam at a different wavelength that can be amplified in the amplifier, and at least two optical shutters provided in beam paths of the respective pulse laser beams between the master oscillators and the amplifier may include adjusting a transmittance of at least one of the two optical shutters on a pulse-to-pulse basis for the pulse laser beams from the master oscillators.

An extreme ultraviolet light generation system according to yet another aspect of this disclosure may include: the aforementioned laser apparatus; a chamber; a target supply unit configured to output a target material toward a predetermined region inside the chamber; a focusing optical element for focusing a pulse laser beam from the laser apparatus in the predetermined region inside the chamber; a target detector for detecting the target material passing through a predetermined position; and a control unit configured to output a signal to cause the laser apparatus to output the pulse laser beam based on a target detection signal from the target detector.

An extreme ultraviolet light generation system according to still another aspect of this disclosure may include: the aforementioned laser apparatus; a chamber; a target supply unit configured to output a target material toward a predetermined region inside the chamber; a focusing optical element for focusing a pulse laser beam from the laser apparatus in the predetermined region inside the chamber; a target detector for detecting the target material passing through a predetermined position; an extreme ultraviolet light energy detector for detecting energy of extreme ultraviolet light emitted from plasma generated when the target material is irradiated by the pulse laser beam in the predetermined region; and a control unit configured to output a signal to the controller to cause the laser apparatus to output the pulse laser beam based on a target detection signal from the target detector and to output a value of the energy required for the amplified pulse laser beam to the controller based on an extreme ultraviolet light energy detection value from the extreme ultraviolet light energy detector.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2 schematically illustrates the configuration of a laser apparatus according to a first embodiment of this disclosure.

FIG. 3 illustrates an example of an optical shutter that includes two polarizers and a Pockels cell according to the first embodiment.

FIG. 4 shows an example of the relationship between a control voltage value of a high-voltage pulse applied to the Pockels cell shown in FIG. 3 and transmittance of the optical shutter.

FIG. 5 shows the relationship between a temporal waveform of a single pulse of a pulse laser beam and an operation timing of the optical shutter according to the first embodiment.

FIG. 6 shows an example of the relationship between a gain in each amplification line and pulse energy of the pulse laser beam according to the first embodiment.

FIG. 7 shows the pulse energy of an amplified pulse laser beam obtained according to the relationship shown in FIG. 6.

FIG. 8 shows gain efficiencies in multi-line amplification and single-line amplification by an amplifier according to the first embodiment.

FIG. 9 schematically illustrates the configuration of a laser apparatus according to a second embodiment of this disclosure.

FIG. 10 is a timing chart showing beam intensities of pulse laser beams outputted from respective master oscillators according to the second embodiment.

FIG. 11 is a timing chart showing beam intensities of the pulse laser beams transmitted through respective optical shutters for multi-line amplification according to the second embodiment.

FIG. 12 is a timing chart showing beam intensities of the pulse laser beams amplified by the amplifier(s) through the multi-line amplification according to the second embodiment.

FIG. 13 is a timing chart showing a beam intensity of a pulse laser beam outputted from the laser apparatus after the multi-line amplification according to the second embodiment.

FIG. 14 is a timing chart showing beam intensities of pulse laser beams outputted from respective master oscillators according to the second embodiment.

FIG. 15 is a timing chart showing a beam intensity of a pulse laser beam transmitted through an optical shutter for single-line amplification according to the second embodiment.

FIG. 16 is a timing chart showing a beam intensity of the pulse laser beam amplified by the amplifier(s) through the single-line amplification according to the second embodiment.

FIG. 17 is a timing chart showing a beam intensity of the pulse laser beam outputted from the laser apparatus after the single-line amplification according to the second embodiment.

FIG. 18 is a flowchart showing an overall operation of the laser apparatus according to the second embodiment.

FIG. 19 shows an example of a control voltage value calculation routine in Step S104 of FIG. 18.

FIG. 20 shows an example of an optical shutter switching routine in Step S106 of FIG. 18.

FIG. 21 schematically illustrates the configuration of an EUV light generation system according to a third embodiment of this disclosure.

FIG. 22 shows a flowchart showing a portion of an overall operation of the EUV light generation system shown in FIG. 21.

FIG. 23 shows a flowchart showing another portion of an overall operation of the EUV light generation system shown in FIG. 21.

FIG. 24 shows a variation of the optical shutter shown in FIG. 3.

FIG. 25 shows an example of a regenerative amplifier in the laser apparatus shown in FIG. 9.

FIG. 26 shows a first configuration example of a beam path adjusting unit in the laser apparatus shown in FIG. 2 and an arrangement of the master oscillators with respect to the beam path adjusting unit.

FIG. 27 schematically illustrates the configuration of a seed laser device that includes a multi-longitudinal mode master oscillator.

### DESCRIPTION OF PREFERRED EMBODIMENTS

Hereinafter, selected embodiments of this disclosure will be described in detail with reference to the accompanying drawings. The embodiments to be described below are merely illustrative in nature and do not limit the scope of this disclosure. Further, the configuration(s) and operation(s) described in each embodiment are not all essential in implementing this disclosure. Note that like elements are referenced by like reference numerals and characters, and duplicate descriptions thereof will be omitted herein. The embodiments of this disclosure will be illustrated following the table of contents below.

### Contents

### 1. Overview

### 2. Terms

### 3. Extreme Ultraviolet Light Generation System

### 3.1 Configuration

### 3.2 Operation

### 3.3 Pulse-to-Pulse Energy Control

### 4. Laser Apparatus for Multi-line Amplification (First Embodiment)

### 4.1 Configuration

### 4.1.1 Optical Shutter (Combination of Pockels Cell and Polarizers)

### 4.2 Operation

### 4.3 Effect

### 4.4 Multi-line Amplification

### 5. Laser Apparatus Including Multiple Amplifiers (Second Embodiment

### 5.1 Configuration

### 5.2 Operation

### 5.3 Effect

### 5.4 Timing Chart

### 5.4.1 Multi-line Amplification

### 5.4.2 Single-line Amplification

### 5.5 Flowchart

### 6. Extreme Ultraviolet Light Generation System Including Laser Apparatus (Third Embodiment)

### 6.1 Configuration

### 6.2 Operation

### 6.3 Flowchart

### 7. Supplementary Descriptions

### 7.1 Variation of Optical Shutter

### 7.2 Regenerative Amplifier

### 7.3 Beam Path Adjusting Unit

### 7.4 Seed Laser Device Including Multi-Longitudinal Mode Master Oscillator and Spectroscope

### 1. Overview

In one or more of the embodiments of this disclosure, the pulse energy of one or more pulse laser beams at different wavelengths entering an amplifier may be controlled for each wavelength, whereby the total energy of an amplified pulse laser beam can be controlled.

### 2. Terms

Terms used in this application may be interpreted as follows. The term “plasma generation region” may refer to a three-dimensional space in which plasma is to be generated. The term “burst operation” may refer to an operation mode or state in which a pulse laser beam or pulse extreme ultraviolet (EUV) light is outputted at a predetermined repetition rate during a predetermined period and the pulse laser beam or the pulse EUV light is not outputted outside of the predetermined period. In a beam path of a laser beam, a direction or side closer to the laser apparatus is referred to as “upstream,” and a direction or side closer to the plasma generation region is referred to as “downstream.” The “predetermined repetition rate” does not have to be a constant repetition rate but may, in some examples, be a substantially constant repetition rate.

In an optical element, the “plane of incidence” refers to a plane perpendicular to the surface on which the pulse laser beam is incident and containing the beam axis of the pulse laser beam incident thereon. A polarization component perpendicular to the plane of incidence is referred to as the “S-polarization component,” and a polarization component parallel to the plane of incidence is referred to as the “P-polarization component.”

Further, in the description to follow, the term “single-line amplification” may mean that a laser beam is amplified in one amplification line (e.g., P(20)) of a plurality of amplification lines of a gain medium containing CO₂ gas, for example. The term “multi-line amplification” may mean that a laser beam is amplified in two or more amplification lines of the plurality of amplification lines of the gain medium.

### 3. Extreme Ultraviolet Light Generation System

### 3.1 Configuration

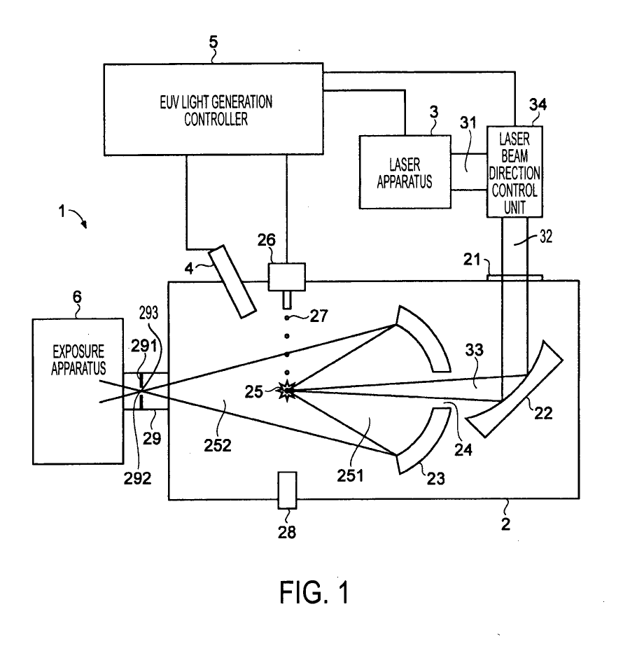

FIG. 1 schematically illustrates the configuration of an exemplary LPP type EUV light generation system. The LPP type EUV light generation system 1 may include at least one laser apparatus 3. As illustrated in FIG. 1 and described in detail below, the EUV light generation system 1 may include a chamber 2, a target supply unit 26 (a target generator, for example), and so forth. The chamber 2 may be airtightly sealed. The target supply unit 26 may be mounted to the chamber 2 so as to penetrate a wall of the chamber 2, for example. A target material to be supplied by the target supply unit 26 may include, but is not limited to, tin, terbium, gadolinium, lithium, xenon, or any combination thereof.

The chamber 2 may have at least one through-hole formed in its wall, and a pulse laser beam 32 may travel through the through-hole. Alternatively, the chamber 2 may be provided with a window 21, through which the pulse laser beam 32 may travel into the chamber 2. An EUV collector mirror 23 having a spheroidal surface may be disposed inside the chamber 2, for example. The EUV collector mirror 23 may have a multi-layered reflective film formed on the spheroidal surface thereof. The reflective film may include a molybdenum layer and a silicon layer being laminated alternately, for example. The EUV collector mirror 23 may have a first focus and a second focus, and preferably be disposed such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system 1 may further include an EUV light generation controller 5 and a target sensor 4. The target sensor 4 may have an imaging function and detect at least one of the presence, the trajectory, and the position of a target.

Further, the EUV light generation system 1 may include a connection part 29 for allowing the interior of the chamber 2 and the interior of the exposure apparatus 6 to be in communication with each other. A wall 291 having an aperture 293 may be provided inside the connection part 29, and the wall 291 may be positioned such that the second focus of the EUV collector mirror 23 lies in the aperture 293 formed in the wall 291.

The EUV light generation system 1 may also include a laser beam direction control unit 34, a laser beam focusing mirror 22, and a target collector 28 for collecting targets 27. The laser beam direction control unit 34 may include an optical element for defining the direction into which the laser beam travels and an actuator for adjusting the position and the orientation (posture) of the optical element.

### 3.2 Operation

With continued reference to FIG. 1, a pulse laser beam 31 outputted from the laser apparatus 3 may pass through the laser beam direction control unit 34 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target generator 26 may output the targets 27 toward the plasma generation region 25 inside the chamber 2. The target 27 may be irradiated by at least one pulse of the pulse laser beam 33. The target 27, which has been irradiated by the pulse laser beam 33, may be turned into plasma, and rays of light including EUV light 251 may be emitted from the plasma. The EUV light 251 may be reflected selectively by the EUV collector mirror 23. EUV light 252 reflected by the EUV collector mirror 23 may travel through the intermediate focus region 292 and be outputted to the exposure apparatus 6. The target 27 may be irradiated by multiple pulses included in the pulse laser beam 33.

The EUV light generation controller 5 may be configured to integrally control the EUV light generation system 1. The EUV light generation controller 5 may be configured to process image data of the target 27 captured by the target sensor 4. Further, the EUV light generation controller 5 may be configured to control at least one of the timing at which the target 27 is outputted and the direction into which the target 27 is outputted (e.g., the timing at which and/or direction in which the target is outputted from target generator 26). Furthermore, the EUV light generation controller 5 may be configured to control at least one of the timing at which the laser apparatus 3 oscillates (e.g., by controlling laser apparatus 3), the direction in which the pulse laser beam 31 travels (e.g., by controlling laser beam direction control unit 34), and the position at which the pulse laser beam 33 is focused (e.g., by controlling laser apparatus 3, laser beam direction control unit 34, or the like), for example. It will be appreciated that the various controls mentioned above are merely examples, and other controls may be added as necessary.

### 3.3 Pulse-to-Pulse Energy Control

An EUV light generation system for a semiconductor exposure apparatus may be required to generate EUV light in pulses at a predetermined repetition rate for exposing wafers in the exposure apparatus. In order to transfer a circuit pattern on a mask onto a resist on a wafer with high precision, an exposure amount by EUV light may preferably be controlled with high precision.

For example, in an EUV light generation system including a laser apparatus, pulse energy of outputted pulsed EUV light may be controlled by controlling pulse energy of a pulse laser beam outputted from the laser apparatus.

Accordingly, in one or more of the embodiments of this disclosure, a technique for controlling the energy of the pulse laser beam outputted from the laser apparatus on a pulse-to-pulse basis (hereinafter, this may be referred to as “pulse-to-pulse energy control”) will be disclosed.

An EUV light generation system may include a laser apparatus that includes an amplifier containing a mixed gas including CO₂ gas as a gain medium (hereinafter, simply referred to as CO₂ gas amplifier) in order to increase output power of the pulse laser beam. However, when a master oscillator power amplifier (MOPA) method is employed in a laser apparatus that includes a CO₂ gas amplifier, the pulse-to-pulse energy control may be difficult, if not impossible, in the following respects.

One of the issues is that pulse energy of a pulse laser beam amplified in a CO₂ gas amplifier may be saturated. Here, the term “saturation” may mean that the pulse energy of the pulse laser beam is in an asymptotic state at a certain value even with an increase in inputted pulse energy. In this case, even when the pulse energy of the pulse laser beam from the master oscillator is controlled on a pulse-to-pulse basis, the effect of the pulse-to-pulse energy control may hardly be reflected on the amount of change in the pulse energy of the amplified pulse laser beam. That is, the energy controllability of the amplified pulse laser beam may be low.

Another issue is that even when the excitation intensity in an amplifier can be controlled on a pulse-to-pulse basis, it may be hard to control the pulse energy of the amplified pulse laser beam on a pulse-to-pulse basis with high precision. This is because the response speed of the change in a gain to the change in RF excitation energy given to the gain medium may be slow with respect to the repetition rate (e.g., 100 kHz) of the pulse laser beam.

Accordingly, in this disclosure, the following embodiments will be illustrated.

### 4. Laser Apparatus for Multi-Line Amplification

### First Embodiment

A laser apparatus in which a pulse laser beam is amplified using two or more amplification lines of a CO₂ gas gain medium will be illustrated as an example.

### 4.1 Configuration

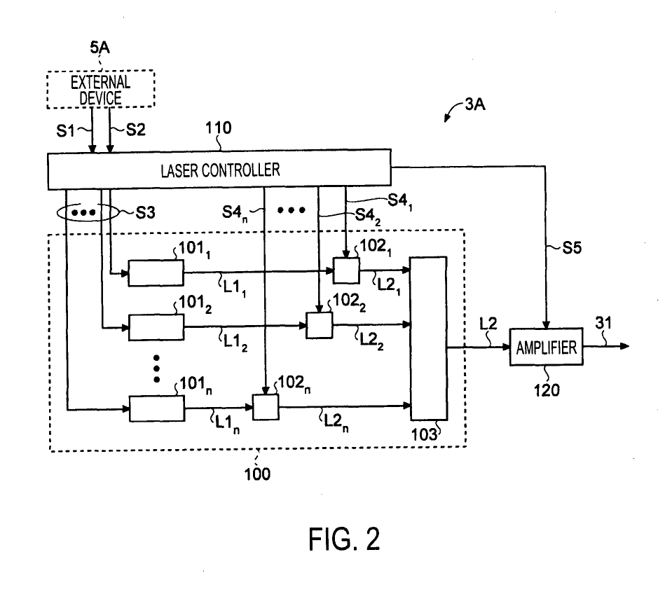

FIG. 2 schematically illustrates the configuration of a laser apparatus 3A according to a first embodiment. As shown in FIG. 2, the laser apparatus 3A may include a seed laser device 100, a laser controller 110, and an amplifier 120. The amplifier 120 may be a CO₂ gas amplifier, but this disclosure is not limited thereto. Further the amplifier 120 may be provided in plurality. When a plurality of amplifiers 120 is used, these amplifiers may be connected serially.

The seed laser device 100 may include master oscillators 101₁ through 101ₙ, optical shutters 102₁ through 102ₙ, and a beam path adjusting unit 103. Each of the master oscillators 101₁ through 101ₙ may, for example, be a semiconductor laser (e.g., quantum cascade laser), a solid-state laser, or the like. Each of the master oscillators 101₁ through 101ₙ may be configured to oscillate in a single-longitudinal mode and at a different wavelength from one another. In that case, the master oscillators 101₁ through 101ₙ may output respective pulse laser beams L1₁ through L1ₙ, each having an extremely narrow wavelength spectrum. However, this disclosure is not limited thereto. Each of the master oscillators 101₁ through 101ₙ may, for example, be configured to oscillate in a multi-longitudinal mode. Alternatively, a pulse laser beam outputted from a single master oscillator configured to oscillate in multi-longitudinal mode may be split into a plurality of such single-longitudinal mode pulse laser beams L1₁ through L1ₙ as shown in FIG. 2, using a prism, a grating, or the like. This split of a multi-longitudinal mode pulse laser beam will be described in detail later with an example.

The master oscillators 101₁ through 101ₙ may preferably be configured to output the respective pulse laser beams L1₁ through L1ₙ at respective wavelengths that are contained in any one of the amplification lines in the amplifier 120.

The optical shutters 102₁ through 102ₙ may be provided downstream from the respective master oscillators 101₁ through 101ₙ. The optical shutters 102₁ through 102ₙ may be provided between the respective master oscillators 101₁ through 101ₙ and the beam path adjusting unit 103. Switching of the optical shutters 102₁ through 102ₙ may be controlled by the laser controller 110. The laser controller 110 may preferably be configured to be capable of controlling the opening (transmittance) of each of the optical shutters 102₁ through 102ₙ independently from one another. The opening may be a ratio of the pulse energy of the outputted laser beam with respect to the inputted laser beam. The opening being large may mean that the transmittance of the pulse laser beams L1₁ through L1ₙ entering the respective optical shutters 102₁ through 102ₙ is high. Accordingly, the pulse energy (e.g., beam intensity) of pulse laser beams L2₁ through L2ₙ transmitted through the respective optical shutters 102₁ through 102ₙ may depend on the transmittance (opening) of the respective optical shutters 102₁ through 102ₙ.

The pulse laser beams L2₁ through L2ₙ transmitted through the respective optical shutters 102₁ through 102ₙ may then enter the beam path adjusting unit 103, have their respective beam paths adjusted thereby so as to substantially coincide with one another (i.e., into a single predetermined beam path), and be outputted as a pulse laser beam L2 from the seed laser device 100. The pulse laser beam L2 may then enter the amplifier 120 and be amplified in the amplifier 120. An excitation control signal S5 may be sent from the laser controller 110 to an RF power source (not shown) of the amplifier 120 in synchronization with a timing at which an amplification region in the amplifier 120 is filled with the pulse laser beam L2, for example. Upon receiving the excitation control signal S5, the RF power source may supply excitation power to the amplifier 120. With this, the pulse laser beam L2 passing through the amplification region inside the amplifier 120 may be amplified.

### 4.1.1 Optical Shutter (Combination of Pockels Cell and Polarizers)

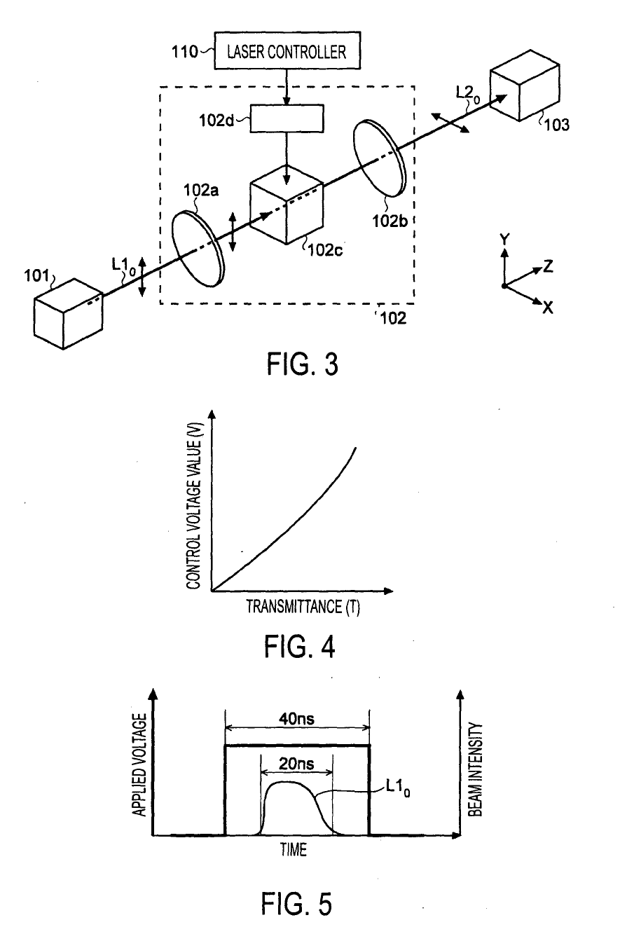

An example of the optical shutter according to the first embodiment will now be described in detail with reference to the drawings. FIG. 3 illustrates an example of an optical shutter 102 that includes two polarizers 102a and 102b and a Pockels cell 102c. Here, each of the polarizers 102a and 102b is of a transmissive type.

In the configuration shown in FIG. 3, the polarizer 102a may be positioned so as to transmit a polarization component in the Y-direction of a laser beam incident thereon and block a polarization component in the X-direction thereof. Meanwhile, the polarizer 102b may be positioned so as to transmit, for example, the polarization component in the X-direction of a laser beam incident thereon and block the polarization component in the Y-direction thereof. In this way, the polarizers 102a and 102b may be positioned so as to transmit polarization components in different directions. In this example, the polarizers 102a and 102b may be positioned such that the polarization directions of the transmitted laser beam may differ by 90 degrees.

A high-voltage pulse may be applied to the Pockels cell 102c by a high-voltage power source 102d under the control of the laser controller 110. The Pockels cell 102c may modulate the phase of an entering laser beam in accordance with a voltage (control voltage value) of the high-voltage pulse applied thereto. Accordingly, the pulse energy of a pulse laser beam L2₀ outputted from the optical shutter 102 may be controlled on a pulse-to-pulse basis by controlling the control voltage value applied to the Pockels cell 102c as appropriate. In other words, by controlling the control voltage value of the high-voltage pulse applied to the Pockels cell 102c, the transmittance (opening) of the optical shutter 102 may be controlled.

FIG. 4 shows an example of the relationship between the control voltage value (V) applied to the Pockels cell 102c and the transmittance (T) of the optical shutter 102. As shown in FIG. 4, the optical shutter 102 may be configured such that the control voltage value (V) and the transmittance (T) may be in the relationship of one-to-one correspondence. Thus, the control voltage value (V) may be calculated from the transmittance (T) required of the optical shutter 102, and a high-voltage pulse of this control voltage value (V) may be applied to the Pockels cell 102c. With this, the pulse energy of the pulse laser beam L2₀ outputted from the optical shutter 102 may be controlled by controlling the control voltage value (V). This may also be applicable in a case where each of the polarizers 102a and 102b is of a reflective type.

A pulse laser beam L1₀ entering the optical shutter 102 may first be incident on the polarizer 102a. The polarizer 102a may transmit a polarization component in the Y-direction of the pulse laser beam L1₀ incident thereon. The component of the pulse laser beam L1₀ transmitted through the polarizer 102a may then enter the Pockels cell 102c.

When a high-voltage pulse is not applied to the Pockels cell 102c, the component of the pulse laser beam L1₀ having entered the Pockels cell 102c may be outputted from the Pockels cell 102c without being subjected to phase modulation, and then be incident on the polarizer 102b. The component of the pulse laser beam L1₀, which is polarized in the Y-direction, may be absorbed by the polarizer 102b. As a result, the pulse laser beam L1₀ may be blocked by the optical shutter 102.

On the other hand, when the high-voltage pulse is applied to the Pockels cell 102c, the phase of the pulse laser beam L1₀ entering the Pockels cell 102c may be modulated in accordance with the control voltage value. As a result, an elliptically-polarized pulse laser beam L1₀ having a phase that has been modulated in accordance with the control voltage value may be outputted from the Pockels cell 102c, and then be incident on the polarizer 102b. A polarization component in the X-direction of the elliptically-polarized pulse laser beam L1₀ may be transmitted through the polarizer 102b and outputted as a pulse laser beam L2₀. In this way, the pulse laser beam L2₀ whose pulse energy has been adjusted in accordance with the control voltage value of the high-voltage pulse applied to the Pockels cell 102c may be outputted from the optical shutter 102. In other words, the pulse laser beam L2₀ having a pulse energy that has been adjusted in accordance with the transmittance corresponding to the control voltage value may be outputted from the optical shutter 102. After the pulse laser beam L2₀ is outputted from the optical shutter 102, the application of the high-voltage pulse may be stopped. For example, the control voltage value may be set to 0 V, to thereby close the optical shutter 102.

When the high-voltage pulse is applied to the Pockels cell 102c in accordance with a passing timing of a single pulse in the pulse laser beam L1₀, a self-oscillation beam or a returning beam from an amplifier disposed downstream therefrom may be suppressed. Further, switching the optical shutter 102 while allowing the master oscillators 101₁ through 101ₙ to oscillate continually at a predetermined repetition rate may allow the pulse laser beam L2₀ to be outputted in burst. That is, the optical shutter 102 may fulfill the functions of both suppressing the self-oscillation beam or the returning beam and generating a burst output.

FIG. 5 shows an operation of the optical shutter on a single pulse in the pulse laser beam according to the first embodiment. As shown in FIG. 5, when, for example, a duration (pulse width) of the pulse laser beam L1₀ is 20 ns, preferably a high-voltage pulse with such a duration that can absorb some timing jitter of the pulse laser beam L1₀ (for example, 40 ns) may be applied to the Pockels cell 102c of the optical shutter 102. Here, when the duration of the high-voltage pulse is too long, the returning beam may not be blocked by the optical shutter 102 in some cases. Accordingly, the duration of the high-voltage pulse may preferably be set appropriately. Further, a Pockels cell typically has a few-nanosecond-responsiveness. Thus, it may be suitably used for an optical shutter in a laser apparatus where high-speed switching is required.

### 4.2 Operation

The overall operation of the laser apparatus 3A shown in FIG. 2 will now be described. The laser controller 110 may be configured to send an oscillation trigger S3 to each of the master oscillators 101₁ through 101ₙ in accordance with an oscillation trigger S1 from an external device 5A. The external device 5A may, for example, be the EUV light generation controller 5 shown in FIG. 1. Upon receiving the oscillation trigger S3, each of the master oscillators 101₁ through 101ₙ may oscillate continually at a predetermined repetition rate. As mentioned earlier, the master oscillators 101₁ through 101ₙ may be configured to output the respective pulse laser beams L1₁ through L1ₙ having central wavelengths that are contained in the amplification lines in the amplifier 120. Timings at which the master oscillators 101₁ through 101ₙ output the respective pulse laser beam L1₁ through L1ₙ may be synchronized with one another.

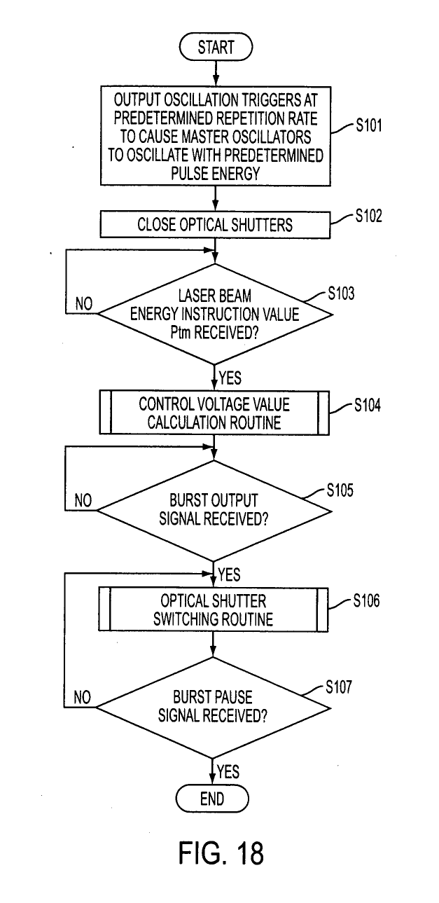

Further, the laser controller 110 may be configured to control the transmittance (opening) of the optical shutters 102₁ through 102ₙ based on a laser beam energy instruction value Ptm (see FIG. 18) from the external device 5A. Here, the relationship between the laser beam energy instruction value Ptm and the transmittance of the optical shutters 102₁ through 102ₙ may be held in a table prepared in advance. Alternatively, a formula for calculating the transmittance of the optical shutters 102₁ through 102ₙ from the laser beam energy instruction value Ptm may be prepared in advance. The table or the formula may be obtained through experiments, simulations, or the like. Further, the relationship between the transmittance required of the optical shutters 102₁ through 102ₙ and the control voltage values of high-voltage pulses S4₁ through S4ₙ to be applied to the respective optical shutters 102₁ through 102ₙ may be stored in a table prepared in advance, as in the aforementioned relationship. Alternatively, a formula for calculating the control voltage value from the required transmittance may be prepared in advance. The table or the formula may be held in a memory (not shown) or the like, and the laser controller 110 may load the table or the formula from the memory as necessary.

Each of the master oscillators 101₁ through 101ₙ may be a so-called continuous wave (CW) laser. In this case, the laser controller 110 may cause the master oscillators 101₁ through 101ₙ to oscillate continuously with constant output power. Then, the laser controller 110 may control the transmittance (opening) and the opening duration of the respective optical shutters 102₁ through 102ₙ based on the laser beam energy instruction value Ptm from the external device 5A, whereby the pulse laser beams L2₁ through L2ₙ may be generated. With such control, the CW laser beams outputted from the respective master oscillators 101₁ through 101ₙ at respectively differing wavelengths may be transmitted through the optical shutter 102₁ through 102ₙ, respectively, whereby the pulse laser beams L2₁ through L2ₙ at respectively different wavelengths and with predetermined pulse energy may be generated.

### 4.3 Effect

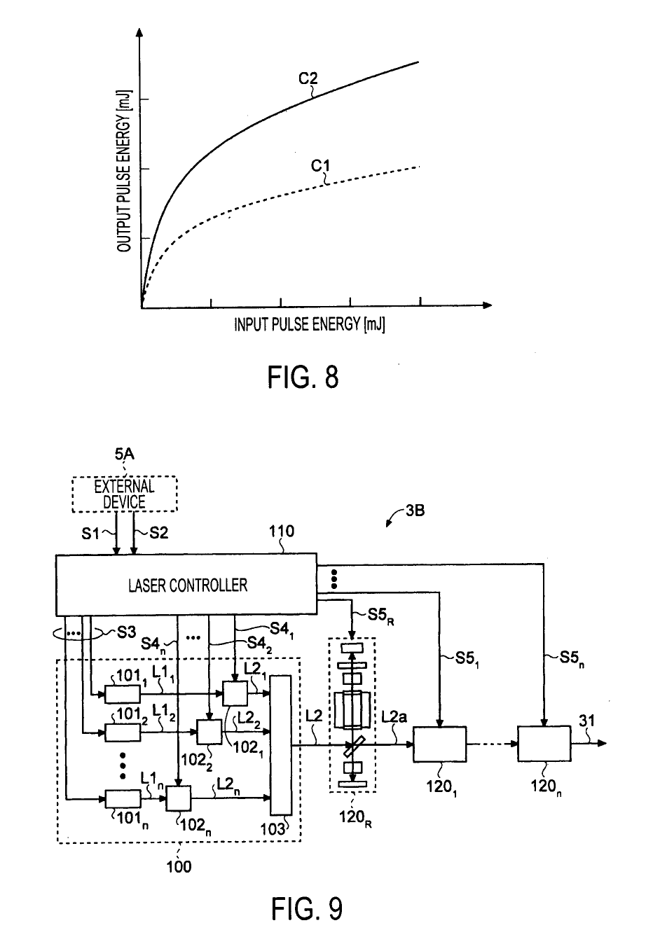

With the above configuration and operation, the pulse energy of the pulse laser beams L2₁ through L2ₙ entering the amplifier 120 may be controlled on a pulse-to-pulse basis by the optical shutters 102₁ through 102ₙ. Here, the pulse energy of the pulse laser beams L2₁ through L2ₙ entering the amplifier 120 may preferably be controlled within a range where the pulse energy of each of the pulse laser beams L2₁ through L2ₙ amplified in a given amplification line does not saturate. With this, the pulse-to-pulse energy control of the pulse laser beams L2₁ through L2ₙ may be reflected on the pulse energy of the pulse laser beam 31 amplified in the amplifier 120. This may make it possible to control the pulse energy of the amplified pulse laser beam 31 to be outputted from the laser apparatus 3A to be controlled with high precision. Further, an energy controllable range (dynamic range) of the pulse laser beam 31 from the laser apparatus 3A may be broadened, as compared to the case of single-line amplification using a single amplification line P(20) (see FIG. 8), for example, of the amplifier 120.

### 4.4 Multi-line Amplification

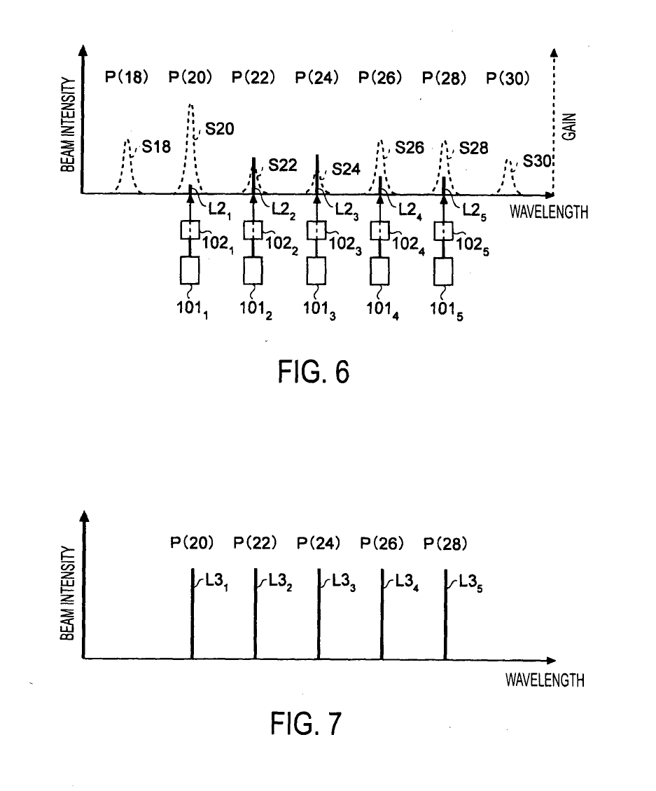

The multi-line amplification by the amplifier 120 will now be discussed. FIG. 6 shows an example of the relationship between gains S18 through S30 of the respective amplification lines P(18) through P(30) in the amplifier 120 and the pulse energy of the pulse laser beams L2₁ through L2₅ transmitted through the respective optical shutters 102₁ through 102₅. Here, the gains S18 through S30 are shown to indicate gain properties in the respective amplification lines. FIG. 7 shows the pulse energy of components L3₁ through L3₅ at respectively different wavelengths contained in the amplified pulse laser beam 31.

As shown in FIG. 6, the transmittance of the optical shutters 102₁ through 102₅ may, for example, be controlled in accordance with the gains S18 through S30 of the respective amplification lines P(18) through P(30). With this, as shown in FIG. 7, the pulse energy of the components L3₁ through L3₅ amplified in the respective amplification lines P(18) through P(30) can become substantially equal.

Adjusting the pulse energy of the pulse laser beams L2₁ through L2₅ by controlling the transmittance of the respective optical shutters 102₁ through 102₅ may make it possible to control the pulse energy of the components L3₁ through L3₅. As a result, the pulse energy of the pulse laser beam 31 outputted from the laser apparatus 3A may be controlled as desired (e.g., to a value requested in the laser beam energy instruction value Ptm) with high precision.

Here, carrying out the pulse-to-pulse energy control using primarily the amplification line P(20), which has a relatively high power conversion efficiency, may lead to energy savings.

FIG. 8 shows the gain efficiencies in the multi-line amplification and the single-line amplification using the amplifier 120. In FIG. 8, a line C1 shows the gain efficiency in the single-line amplification using the amplification line P(20), and a line C2 shows the gain efficiency in the multi-line amplification using the amplification lines P(20) through P(28).

As may be apparent from the comparison between the lines C1 and C2 shown in FIG. 8, the multi-line amplification where there is substantially no saturation in the amplification lines may yield 1.5 times higher output pulse energy than the single-line amplification where there is substantially no saturation in the amplification line. This suggests that the multi-line amplification can yield a 1.5 times broader dynamic range than that of the single-line amplification. Here, the output pulse energy shown in FIG. 8 may be the pulse energy of the pulse laser beam 31 outputted from the laser apparatus 3A.

### 5. Laser Apparatus Including Multiple Amplifiers

### Second Embodiment

A laser apparatus including a plurality of amplifiers will now be described in detail as a second embodiment with reference to the drawings.

### 5.1 Configuration

FIG. 9 schematically illustrates the configuration of a laser apparatus 3B according to the second embodiment. The laser apparatus 3B shown in FIG. 9 may be similar in configuration to the laser apparatus 3A shown in FIG. 2. However, the laser apparatus 3B may include a regenerative amplifier 120_{R} and a plurality of amplifiers 120₁ through 120ₙ. As in the first embodiment, single-longitudinal mode semiconductor lasers may be used as the master oscillators 101₁ through 101ₙ, and each of the semiconductor lasers may be a quantum cascade laser (QCL). The regenerative amplifier 120_{R} may be provided between the seed laser device 100 and the first-stage amplifier 120₁. Each of the regenerative amplifier 120_{R} and the amplifiers 120₁ through 120ₙ may be a CO₂ gas amplifier.

At least one of the master oscillators 101₁ through 101ₙ may be configured to output a pulse laser beam at a different wavelength from the rest of the master oscillators. The master oscillators 101₁ through 101ₙ may preferably be configured to output the pulse laser beam L1₁ through L1ₙ at respective wavelengths contained in any of the amplification lines of the gain bandwidth of the regenerative amplifier 120_{R} and the amplifiers 120₁ through 120ₙ.

### 5.2 Operation

The overall operation of the laser apparatus 3B shown in FIG. 9 will now be described. In the second embodiment, the operation of the seed laser device 100 and the operation of the laser controller 110 on the seed laser device 100 may be similar to those in the first embodiment described above with reference to FIG. 2.

The pulse laser beam L2 outputted from the seed laser device 100 may first be amplified in the regenerative amplifier 120_{R}. The amplification in the regenerative amplifier 120R may be the multi-line amplification. At this point, the pulse width may be adjusted. Thereafter, an amplified pulse laser beam L2a may be sequentially amplified in the amplifiers 120₁ through 120ₙ. The amplification in each of the amplifiers 120₁ through 120ₙ may also be the multi-line amplification. Here, the laser controller 110 may send excitation control signals S5_{R} and S5₁ through S5ₙ to the RF power sources of the regenerative amplifier 120_{R} and the amplifiers 120₁ through 120ₙ, preferably in synchronization with timings at which amplification regions in the regenerative amplifier 120_{R} and the amplifiers 120₁ through 120ₙ are respectively filled with the pulse laser beam L2 or L2a.

### 5.3 Effect

With the above configuration and operation, effects similar to those of the first embodiment may be obtained. As in the first embodiment, when the semiconductor lasers, such as QCLs, are used for the master oscillators 101₁ through 101ₙ and these master oscillators 101₁ through 101ₙ are controlled to oscillate continually at a predetermined repetition rate, heat loads on the master oscillators 101₁ through 101ₙ may not fluctuate, which in turn may stabilize the pulse energy of the pulse laser beam L1₁ through L1ₙ. As a result, the pulse energy of the pulse laser beams L2 and L2a to be amplified may be stabilized as well, and in turn the pulse energy of the pulse laser beam 31 outputted from the laser apparatus 3B may be stabilized.

### 5.4 Timing Chart

The overall operation of the laser apparatus 3B shown in FIG. 9 will now be described with reference to the timing charts.

### 5.4.1 Multi-line Amplification

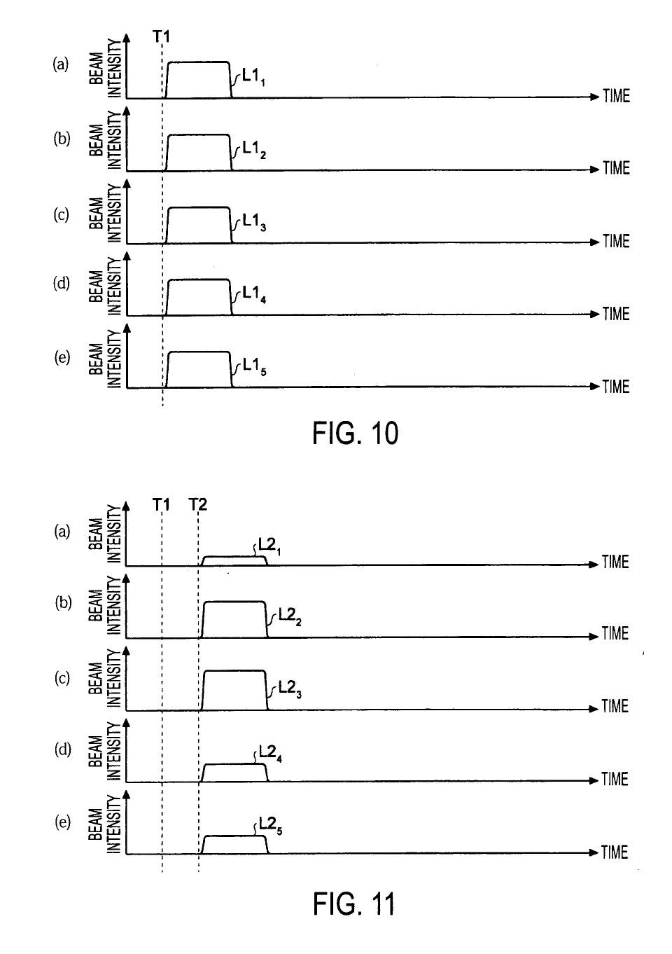

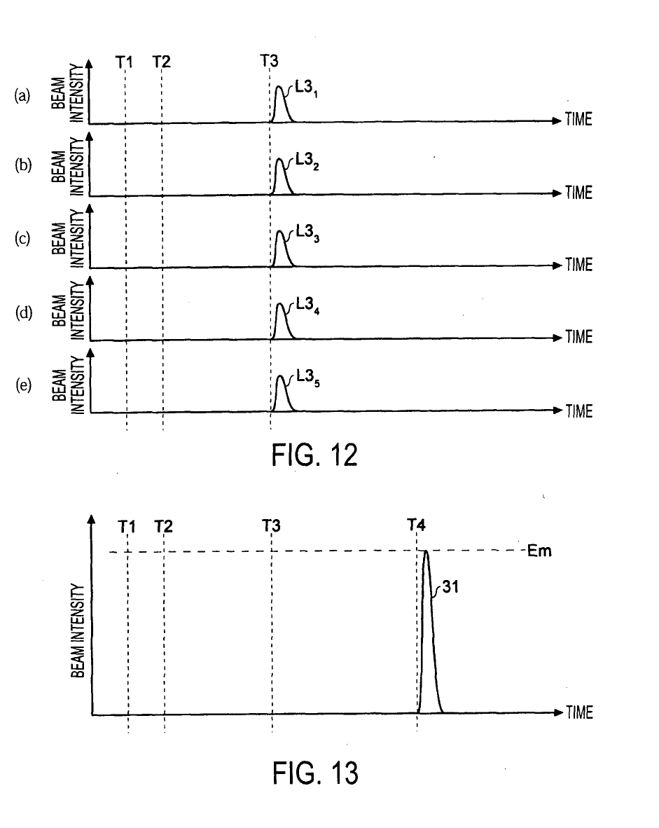

Hereinafter, the overall operation of the laser apparatus 3B including five master oscillators and configured for the multi-line amplification will be described. FIGS. 10 through 13 are timing charts showing the overall operation of the laser apparatus 3B for the multi-line amplification. In the description to follow, a case where the pulse energy of the components L3₁ through L3₅ contained in the pulse laser beam 31 is made substantially equal to one another will be discussed, as described with reference to FIGS. 5 and 6. FIG. 10 is a timing chart showing the beam intensity of the pulse laser beams L1₁ through L1₅ outputted from the respective master oscillators 101₁ through 101₅. FIG. 11 is a timing chart showing the beam intensity of the pulse laser beams L2₁ through L2₅ transmitted through the respective optical shutters 102₁ through 102₅. FIG. 12 is a timing chart showing the beam intensity of the components L3₁ through L3₅ contained in the pulse laser beam 31 amplified in the amplifier 120ₙ. FIG. 13 is a timing chart showing the beam intensity of the pulse laser beam 31 outputted from the laser apparatus 3B.

As shown in FIG. 10, the master oscillators 101₁ through 101₅ may be configured to output the respective pulse laser beams L1₁ through L1₅ with the same beam intensity and at the same timing T1. Here, the pulse laser beams L1₁ through L1₅ shown in FIG. 10 may be outputted from the master oscillators 101₁ through 101₅ continually at a predetermined repetition rate. This may make it possible to thermally stabilize the master oscillators 101₁ through 101₅.

Meanwhile, high-voltage pulses S4₁ through S4₅ of the respective control voltage values may be applied to the respective optical shutters 102₁ through 102₅ at timing T2 (see FIG. 11). Here, the control voltage values may be determined in accordance with the gains of the amplifications lines P(20) through P(28) corresponding to the wavelengths of the respective pulse laser beams L1₁ through L1₅ entering the respective optical shutters 102₁ through 102₅. With this, the transmittance (opening) of the optical shutters 102₁ through 102₅ may preferably be controlled to the transmittance in accordance with the gains of the corresponding amplification lines P(20) through P(28). The timing T2 at which the high-voltage pulses S4₁ through S4₅ are applied to the respective optical shutters 102₁ through 102₅ may be adjusted to the timing at which the pulse laser beams L1₁ through L1₅ enter the respective optical shutters 102₁ through 102₅. As a result, as shown in FIG. 11, the pulse laser beams L2₁ through L2₅ whose beam intensity has been adjusted may be outputted from the respective optical shutters 102₁ through 102₅ substantially simultaneously at the timing T2.

The pulse laser beams L2₁ through L2₅ transmitted through the optical shutters 102₁ through 102₅ may then enter the beam path adjusting unit 103 to have their beam paths made to coincide with one another and be outputted as the pulse laser beam L2. Thereafter, the pulse laser beam L2 may undergo the multi-line amplification in the regenerative amplifier 120_{R} and the amplifiers 120₁ through 120ₙ. Here, the pulse width of the pulse laser beam 31 to be outputted from the laser apparatus 3B may be adjusted by adjusting the operation timing of the regenerative amplifier 120_{R}. As shown in FIG. 12, the components L3₁ through L3₅ with substantially the same beam intensity contained in the pulse laser beam 31 may be outputted from the amplifier 120ₙ at substantially the same timing T3. As a result, as shown in FIG. 13, the pulse laser beam 31 with the beam intensity Em may be outputted from the laser apparatus 3B at a timing T4.

In this example, the pulse laser beams L1₁ through L1₅ are outputted at the same timing T1, whereby the peak of the pulse energy of the pulse laser beam 31 is made higher. However, this disclosure is not limited thereto. For example, by offsetting the timings at which the pulse laser beams L1₁ through L1₅ are outputted, respectively, by a predetermined duration, a pulse laser beam having a larger pulse width may be outputted from the laser apparatus 3B. Even if that is the case, the pulse energy of the pulse laser beam 31 outputted from the laser apparatus 3B can satisfy the laser beam energy instruction value Ptm from the external device 5A.

### 5.4.2 Single-line Amplification

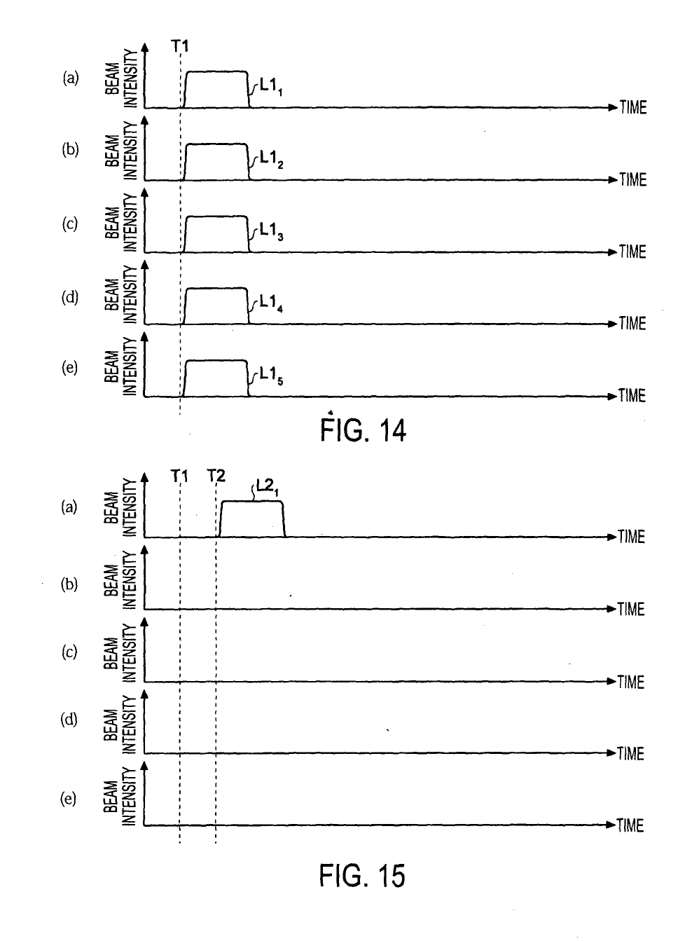

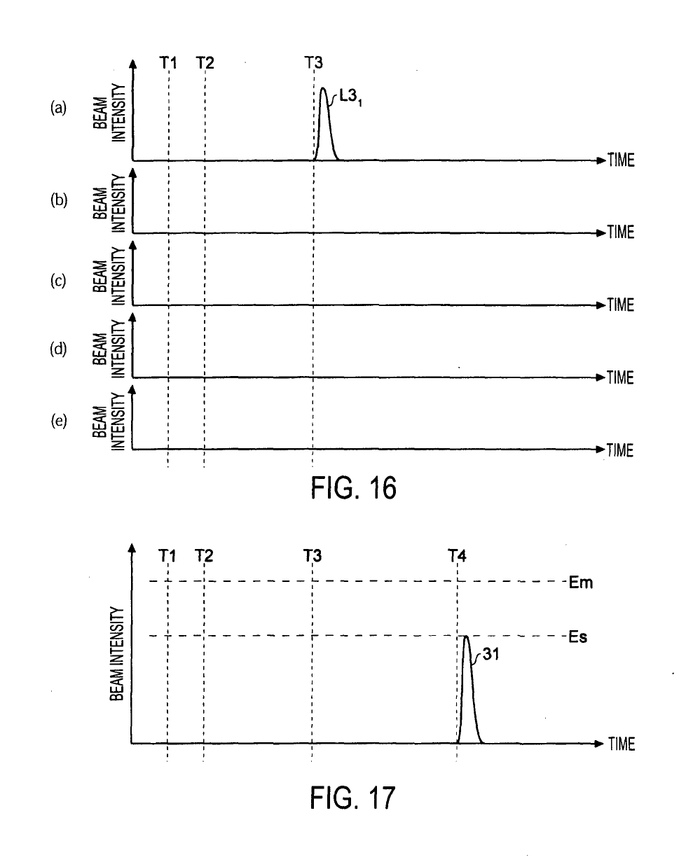

The overall operation of the laser apparatus 3B configured for the single-line amplification will now be described. FIGS. 14 through 17 show the overall operation of the laser apparatus 3B configured for the single-line amplification. Here, a case where only the pulse laser beam L1₁ outputted from the master oscillator 101₁ is amplified will be shown as an example. FIG. 14 is a timing chart showing the beam intensity of the pulse laser beams L1₁ through L1₅ outputted from the respective master oscillators 101₁ through 101₅. FIG. 15 is a timing chart showing the beam intensity of the pulse laser beam L2₁ transmitted through the optical shutter 102₁. FIG. 16 is a timing chart showing the beam intensity of the component L3₁ contained in the pulse laser beam 31 amplified in the amplifier 120. FIG. 17 is a timing chart showing the beam intensity of the pulse laser beam 31 outputted from the laser apparatus 3B.

As shown in FIG. 14, the master oscillators 101₁ through 101₅ may be configured to output the pulse laser beams L1₁ through L1₅ with the same beam intensity and at the same timing T1, as in the case shown in FIG. 10. Here, the pulse laser beams L1₁ through L1₅ may be outputted from the master oscillators 101₁ through 101₅ continually at a predetermined repetition rate. This may make it possible to thermally stabilize the master oscillators 101₁ through 101₅.

Meanwhile, as for the optical shutters 102₁ through 102₅, only the high-voltage pulse S4₁ may be applied to the optical shutter 102₁ for opening the optical shutter 102₁. At this point, the transmittance of the optical shutters 102₂ through 102₅ may preferably be set to 0. As a result, as shown in FIG. 15, the pulse laser beam L2₁ whose beam intensity has been adjusted may be outputted from the optical shutter 102₁ at the timing T2. Here, in section (a) of FIG. 15, the transmittance of the optical shutter 102₁ is set higher, compared to section (a) of FIG. 11.

The pulse laser beam L2₁ transmitted through the optical shutter 102₁ may then enter the beam path adjusting unit 103 to have its beam path adjusted to a predetermined beam path and be outputted as the pulse laser beam L2. The pulse laser beam L2 may then undergo the single-line amplification in the regenerative amplifier 120_{R} and the amplifiers 120₁ through 120ₙ. At this point, the pulse width of the pulse laser beam 31 to be outputted from the laser apparatus 3B may be adjusted by adjusting the operation timing of the regenerative amplifier 120_{R}. As shown in FIG. 16, the component L3₁ amplified in the amplification line P(20) may be outputted from the final-stage amplifier 120 at the timing T3. As a result, as shown in FIG. 17, the pulse laser beam 31 with the beam intensity Es may be outputted from the laser apparatus 3B at a timing T4.

Here, as can be seen from the comparison between FIG. 13 and FIG. 17, the beam intensity Em of the pulse laser beam 31 obtained through the multi-line amplification may be 1.5 times higher than the beam intensity Es of the pulse laser beam 31 obtained through the single-line amplification using the amplification line P(20) which has the highest power conversion efficiency. This suggests that the multi-line amplification may yield a 1.5 times wider dynamic range of the pulse energy control than the single-line amplification. In this way, with the multi-line amplification, the controllability on the pulse energy of the amplified pulse laser beam 31 outputted from the laser apparatus 3B may be improved.

### 5.5 Flowchart

The operation of the laser apparatus 3B shown in FIG. 9 will now be described with reference to the flowcharts. FIG. 18 is a flowchart showing the overall operation of the laser apparatus 3B. The flowchart in FIG. 18 shows the operation of the laser control 110.

As shown in FIG. 18, the laser controller 110 may first start sending oscillation triggers S3 to each of the master oscillators 101₁ through 101ₙ at a predetermined repetition rate for controlling the master oscillators 101₁ through 101ₙ to oscillate with predetermined pulse energy (Step S101). With this, the master oscillators 101₁ through 101ₙ may start outputting the respective pulse laser beams L1₁ through L1ₙ continually at a predetermined repetition rate. Here, the laser controller 110 may be configured to control the optical shutters 102₁ through 102ₙ to be closed (Step S102). This may be achieved by, for example, keeping the control voltage values for the respective optical shutters 102₁ through 102ₙ to 0 V. With this, the pulse laser beams L1₁ through L1ₙ may be blocked by the respective optical shutters 102₁ through 102ₙ. At this point, each of the amplifiers 120₁ through 120ₙ may be brought into an operable state. Here, Step S102 may be carried out prior to Step S101 or simultaneously with Step S101.

Then, the laser controller 110 may stand by until it receives the laser beam energy detection value Ptm required for the pulse laser beam 31 from the external device 5A (Step S103; NO). Upon receiving the laser beam energy instruction value Ptm (Step S103; YES), the laser controller 110 may execute a control voltage value calculation routine (Step S104). In the control voltage value calculation routine, the control voltage values of the high-voltage pulses S4₁ through S4ₙ to be applied to the respective optical shutters 102₁ through 102ₙ may be calculated from the laser beam energy instruction value Ptm.

Then, the laser controller 110 may stand by until it receives a burst output signal S2 requesting a burst output of the pulse laser beam 31 from the external device 5A (Step S105; NO). Upon receiving the burst output signal S2 (Step S105; YES), the laser controller 110 may execute an optical shutter switching routing for switching the optical shutters 102₁ through 102ₙ based on the control voltage values calculated in Step S104 (Step S106). In Step S106, the optical shutters 102₁ through 102ₙ may be switched on a pulse-to-pulse basis for the respective pulse laser beams L1₁ through L1ₙ (pulse-to-pulse energy control).

Thereafter, the laser controller 110 may determine whether or not it has received a burst pause signal requesting the burst output of the pulse laser beam 31 to be paused from the external device 5A (Step S107). When the burst pause signal has been received (Step S107; YES), the laser controller 110 may terminate this operation. On the other hand, when the burst pause signal has not been received (Step S107; NO), the laser controller 110 may return to Step S106 and repeat the subsequent steps.

With the above operation, the pulse energy of the pulse laser beam L2 entering the amplifiers 120₁ through 120ₙ may be controlled on a pulse-to-pulse basis. This in turn may make it possible to control the pulse energy of the amplified pulse laser beam 31 outputted from the laser apparatus 3B to be controlled with high precision. Further, an energy controllable range (dynamic range) of the pulse laser beam 31 outputted from the laser apparatus 3B may be broadened compared to the case of the single-line amplification using a single amplification line (e.g., P(20)) in each of the amplifiers 120₁ through 120ₙ.

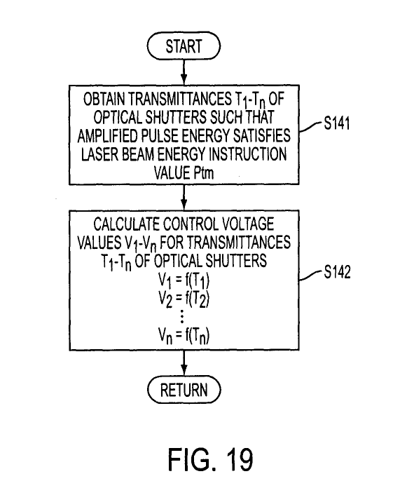

The control voltage value calculation routine in Step S104 of FIG. 18 will now be described in detail with reference to FIG. 19. As shown in FIG. 19, in the control voltage value calculation routine, the laser controller 110 may obtain the transmittances T₁ through Tₙ of the respective optical shutters 102₁ through 102ₙ such that the pulse energy of the amplified pulse laser beam 31 satisfies the laser beam energy instruction value Ptm (Step S141). The relationship between the laser beam energy instruction value Ptm and the transmittances T₁ through Tₙ may be held in a table prepared in advance as stated above. Alternatively, a formula for calculating the transmittances T₁ through Tₙ of the respective optical shutters 102₁ through 102ₙ from the laser beam energy instruction value Ptm may be prepared in advance. The table or the formula may be obtained through experiments, simulations, or the like.

Then, the laser controller 110 may calculate control voltage values V₁ through Vₙ of the high-voltage pulses S4₁ through S4ₙ to be applied to the respective optical shutters 102₁ through 102ₙ from the obtained transmittances T₁ through Tₙ of the optical shutters 102₁ through 102ₙ (Step S142). Thereafter, the laser controller 110 may return to the operation shown in FIG. 18. Here, the formula used in Step S142 may be prepared in advance based on experiments, simulations, or the like. Alternatively, the relationship between the transmittances and the control voltage values may be stored in a table prepared in advance.

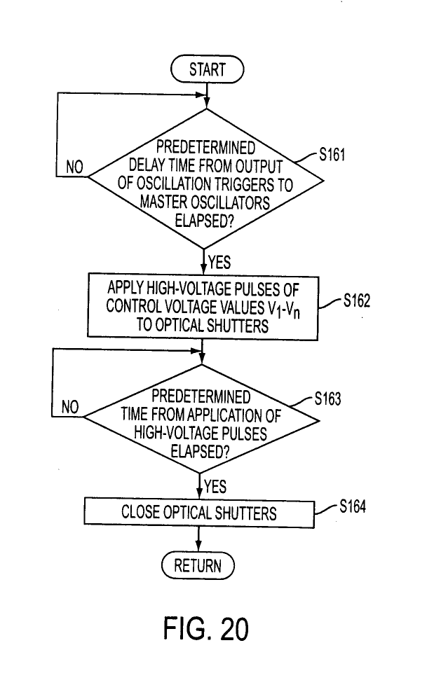

The optical shutter switching routine in Step S106 of FIG. 18 will now be described in detail with reference to FIG. 20. As shown in FIG. 20, in the optical shutter switching routine, the laser controller 110 may stand by until a predetermined delay time from an output of the oscillation trigger S3 to each of the master oscillators 101₁ through 101ₙ elapses (Step S161; NO). The predetermined delay time may be a period from an input of the oscillation trigger S3 into each of the master oscillators 101₁ through 101ₙ until the pulse laser beams L1₁ through L1ₙ enter the respective optical shutters 102₁ through 102ₙ.

The determination of whether or not the predetermined delay time has elapsed from the output of the oscillation trigger S3 may be made by, for example, measuring an elapsed time by a timer (not shown). Alternatively, in place of measuring an elapsed time using the timer, a delay circuit may be provided for achieving a predetermined stand-by time from the output of the oscillation trigger S3. In that case, the processing in Step S161 may be realized using hardware. Therefore, the operation of the laser controller 110 may be simplified.

When the predetermined delay time elapses (Step S161; YES), the laser controller 110 may apply the high-voltage pulses S4₁ through S4ₙ of the control voltage values V₁ through Vₙ to the respective optical shutters 102₁ through 102ₙ (Step S162). With this, the optical shutters 102₁ through 102ₙ may be opened in synchronization with the timing at which the pulse laser beams L1₁ through L1ₙ reach the respective optical shutters 102₁ through 102ₙ.

Then, the laser controller 110 may stand by until a predetermined time elapses from the application of the high-voltage pulses S4₁ through S4ₙ (Step S163; NO). This predetermined time may be a period required for the pulse laser beams L1₁ through L1ₙ to pass through the respective optical shutters 102₁ through 102ₙ.

The determination of whether or not the predetermined time has elapsed from the application of the high-voltage pulses S4₁ through S4ₙ may be made by, for example, measuring an elapsed time by a timer (not shown). Alternatively, in place of measuring the elapsed time using the timer, a delay circuit may be provided for achieving a predetermined stand-by time from the application of the high-voltage pulses S4₁ through S4ₙ. In this case, the processing in Step S163 may be realized using hardware. Therefore, the operation of the laser controller 110 may be simplified.

When the predetermined time elapses (Step S163; YES), the laser controller 110 may stop the application of the high-voltage pulses S4₁ through S4ₙ to the respective optical shutters 102₁ through 102ₙ, to thereby close the optical shutters 102₁ through 102ₙ (Step S164). Thereafter, the laser controller 110 may return to the operation shown in FIG. 18.

### 6. Extreme Ultraviolet Light Generation System Including Laser Apparatus

### Third Embodiment

An EUV light generation system 1C that includes the laser apparatus 3B will be described in detail as a third embodiment with reference to the drawings.

### 6.1 Configuration

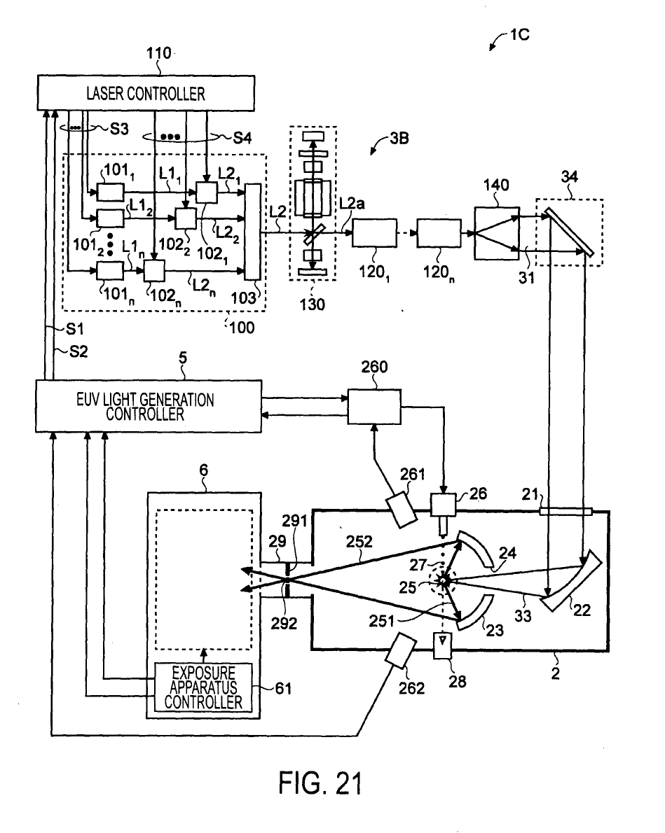

FIG. 21 schematically illustrates the configuration of the EUV light generation system 1C according to the third embodiment. The EUV light generation system 1C shown in FIG. 21 may be similar in configuration to the EUV light generation system 1 shown in FIG. 1, but may differ in that a target controller 260 and an EUV light energy detector 262 are added and that the target sensor 4 and the laser apparatus 3 may respectively be replaced by a target detector 261 and the laser apparatus 3B.

### 6.2 Operation

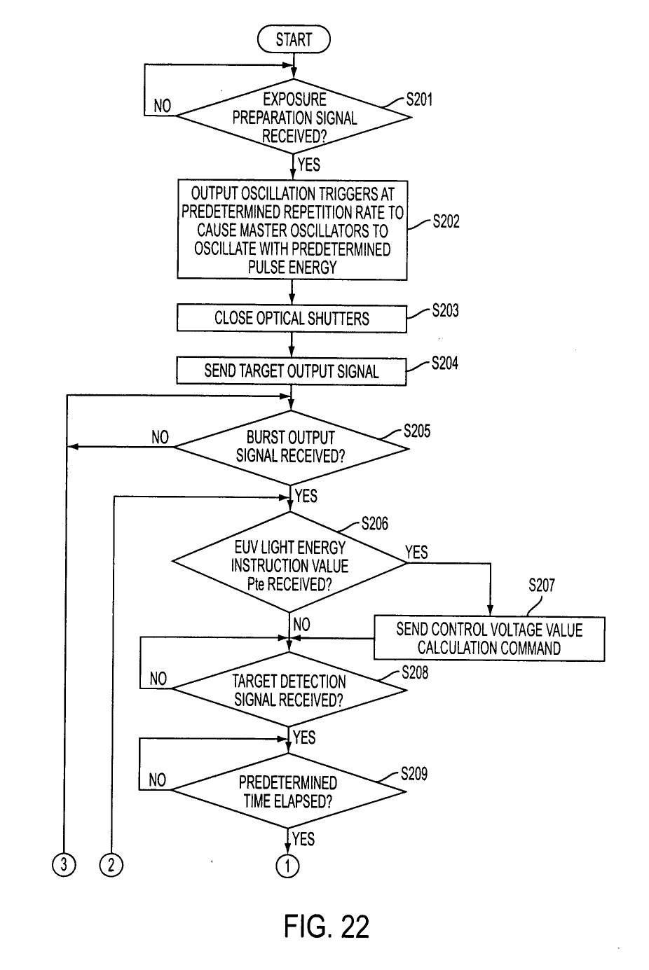

The overall operation of the EUV light generation system 1C shown in FIG. 21 will now be described. The EUV light generation controller 5 may first receive an EUV light energy instruction value Pte (see FIG. 22) required for EUV light 252 and a burst output signal from an exposure apparatus controller 61. The EUV light generation controller 5 may send a target output signal to the target generator 26 via the target controller 260. With this, a target 27 may be outputted from the target generator 26.

The target detector 261 may detect the target 27 outputted from the target generator 26 passing a predetermined position inside the chamber 2. Here, the predetermined position may be set to any position in a trajectory of the target 27 between the target generator 26 and the plasma generation region 25. Upon detecting the target 27, the target detector 261 may output a target detection signal. This target detection signal may be sent to the EUV light generation controller 5 via the target controller 260.

The EUV light generation controller 5 may send the laser beam energy instruction value Ptm to the laser controller 110 based on the EUV light energy instruction value Pte received from the exposure apparatus controller 61 or on a detected value reflecting the energy of the EUV light 252 received from the EUV light energy detector 262, which will be described later.

Then, the EUV light generation controller 5 may send an oscillation trigger S1 to the laser controller 110 so that the target 27 is irradiated by the pulse laser beam 33 when the target 27 arrives in the plasma generation region 25. The timing here may be adjusted based on the burst output signal of the EUV light 252 received from the exposure apparatus controller 61 or on the target detection signal received from the target controller 260.

The laser controller 110 may send the oscillation triggers S3 to the master oscillators 101₁ through 101ₙ and apply the high-voltage pulses S4₁ through S4ₙ to the respective optical shutters 102₁ through 102ₙ. With this, the pulse laser beam 31 may be outputted from the laser apparatus 3B.

The pulse laser beam 31 outputted from the laser apparatus 3B may travel through the laser beam direction control unit 34, and enter the chamber 2 through the window 21. Then, the pulse laser beam 31 may be reflected by the laser beam focusing mirror 22, and be focused as the pulse laser beam 33 on the target 27 passing through the plasma generation region 25 inside the chamber 2. With this, the target 27 may be turned into plasma, and the light 251 including the EUV light 252 may be emitted from the plasma.

The EUV light energy detector 262 may detect a value reflecting the energy of at least the EUV light 252 included in the light 251. For example, the EUV light energy detector 262 may detect an energy value of the EUV light component contained in the light 251 emitted from the plasma. The detected energy value may be sent to the EUV light generation controller 5.

### 6.3 Flowchart

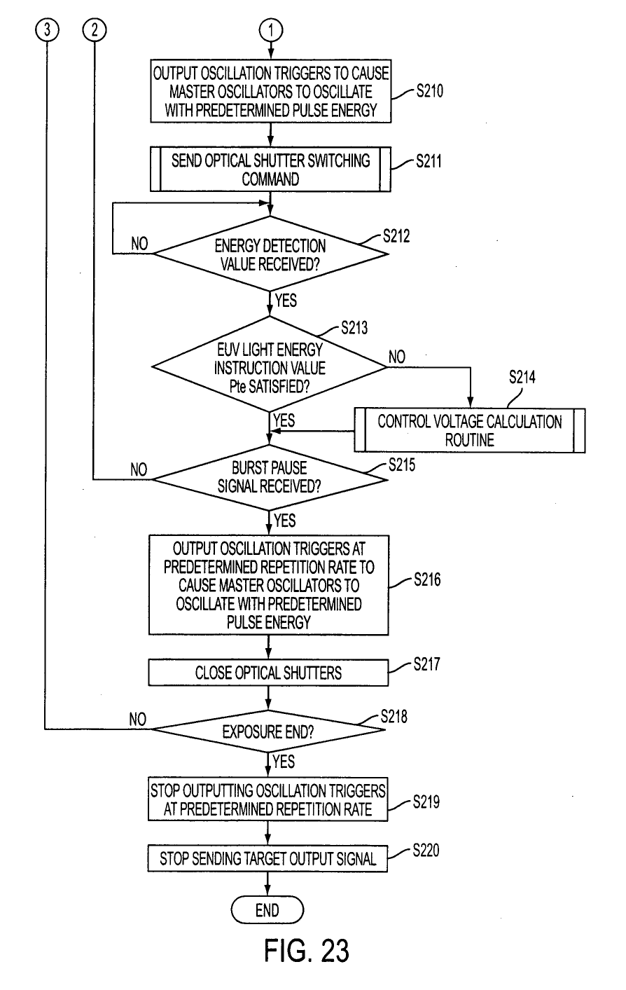

The overall operation of the EUV light generation system 1C shown in FIG. 21 will now be described with reference to the drawings. FIGS. 22 and 23 show a flowchart of the overall operation of the EUV light generation system 1C. Here, the flowchart in FIGS. 22 and 23 shows the operation of the EUV light generation controller 5.

As shown in FIG. 22, the EUV light generation controller 5 may first stand by until it receives an exposure preparation signal from the exposure apparatus controller 61 instructing the preparation for exposure (Step S201; NO). The exposure preparation signal may be inputted to the EUV light generation controller 5 in order for the EUV light generation system 1C to be brought into a state where the exposure operation can be started immediately after receiving the burst output signal. Upon receiving the exposure preparation signal (Step S201; YES), the EUV light generation controller 5 may start outputting the oscillation trigger S1 to the laser controller 110 at a predetermined repetition rate for controlling the master oscillators 101₁ through 101ₙ to oscillate with predetermined pulse energy (Step S202). The laser controller 110 may then output the oscillation triggers S3 to the master oscillators 101₁ through 101ₙ at a predetermined repetition rate in accordance with the oscillation trigger S1. At this point, the master oscillators 101₁ through 101ₙ may start oscillating at a predetermined repetition rate so as to facilitate thermal stability. The master oscillators 101₁ through 101ₙ may preferably be controlled to operate under a constant operation condition.

Further, the EUV light generation controller 5 may control the laser controller 110 to close the optical shutters 102₁ through 102ₙ (Step S203). With this, the pulse laser beams L1₁ through L1ₙ may be blocked by the respective optical shutters 102₁ through 102ₙ. At this point, each of the amplifiers 120₁ through 120ₙ may be brought into an operable state. Here, Step S203 may be carried out prior to Step S202 or simultaneously with Step S202. Further, the EUV light generation controller 5 may control the target controller 260 to send the target output signal to the target generator 26 for causing the target generator 26 to output a target 27 (Step S204). With this, targets 27 may be outputted from the target generator 26 at a predetermined repetition rate toward the plasma generation region 25. Here, the target generator 26 may be of a continuous-jet type configured to output targets 27 continuously at a predetermined repetition rate. Alternatively, the target generator 26 may be of an on-demand type configured to output a target 27 in accordance with an instruction from the target controller 260.

Then, the EUV light generation controller 5 may stand by until it receives a burst output signal from the exposure apparatus controller 61 for requesting a burst output of the EUV light 252 (Step S205; NO). Upon receiving the burst output signal (Step S205; YES), the EUV light generation controller 5 may determine whether or not it has received the EUV light energy instruction value Pte from the exposure apparatus controller 61 specifying the energy required for the EUV light 252 (Step S206). When the EUV light energy instruction value Pte has been received (Step S206; YES), the EUV light generation controller 5 may send a control voltage value calculation command to the laser controller 110 for causing the laser controller 110 to execute the control voltage value calculation routine (Step S207). Thereafter, the EUV light generation controller 5 may proceed to Step S208. The laser controller 110 may execute the control voltage value calculation routine in response to the control voltage value calculation command. Here, the control voltage value calculation routine may be similar to the operation shown in FIG. 19. Thus, a detailed description thereof will be omitted here.

On the other hand, when the EUV light energy instruction value Pte has not been received (Step S206; NO), the EUV light generation controller 5 may proceed to Step S208. However, when the EUV light energy instruction value Pte has never been received since the EUV light generation system 1C is started, the EUV light generation controller 5 may load the EUV light energy instruction value Pte stored in a memory (not shown) or the like, and send the control voltage value calculation command to the laser controller 110 based on the loaded EUV light energy instruction value Pte.

In Step S208, the EUV light generation controller 5 may stand by until it receives a target detection signal from the target detector 261 (Step S208; NO). Upon receiving the target detection signal (Step S208; YES), the EUV light generation controller 5 may stand by until a predetermined time elapses from the reception of the target detection signal (Step S209; NO). Here, the predetermined time may be a delay time for adjusting the timing at which the pulse laser beam 31 is outputted so that the detected target 27 can be irradiated by the pulse laser beam 33 in the plasma generation region 25. The determination of whether or not the predetermined time has elapsed from the reception of the target detection signal may be made by, for example, measuring an elapsed time by a timer (not shown). Alternatively, in place of measuring the elapsed time using the timer, a delay circuit may be provided for delaying the oscillation triggers S3 to be outputted to the master oscillators 101₁ through 101ₙ in Step S210 to follow (see FIG. 23) for a predetermined time. In this case, the processing in Step S209 may be realized using hardware. Therefore, the operation of the laser controller 110 may be simplified.

When the predetermined time has elapsed after the target detection signal is received (Step S209; YES), the EUV light generation controller 5 may cause the laser controller 110 to output new oscillation triggers S3, which are different from the oscillation triggers S3 at the predetermined repetition rate, to the master oscillators 101₁ through 101ₙ to control the master oscillators 101₁ through 101ₙ to oscillate in synchronization with the target detection signals. Here, the new oscillation triggers S3 may include information, such as amplitude and pulse width, for adjusting the output energy of the master oscillators 101₁ through 101ₙ in accordance with the EUV light energy instruction value Pte. Through the operation in Step S210, an output of the targets 27 and an output of the pulse laser beams L1₁ through L1ₙ from the respective master oscillators 101₁ through 101ₙ may be synchronized. Then, the EUV light generation controller 5 may send an optical shutter switching command to the laser controller 110 for causing the laser controller 110 to execute the optical shutter switching routine for switching the optical shutters 102₁ through 102ₙ in accordance with the control voltage values calculated in response to the control voltage value calculation command in Step S207 (Step S211). The laser controller 110 may execute the optical shutter switching routine in response to the optical shutter switching command. Here, the optical shutter switching routine may be similar to the operation shown in FIG. 20. Thus, a detailed description thereof will be omitted here.

Subsequently, the EUV light generation controller 5 may stand by until it receives an energy detection value from the EUV light energy detector 262 (Step S212; NO). Upon receiving the energy detection value (Step S212; YES), the EUV light generation controller 5 may determine whether or not the energy of the detected EUV light 252 satisfies the EUV light energy instruction value Pte (Step S213). When the energy of the detected EUV light 252 satisfies the EUV light energy instruction value Pte (Step S213; YES), the EUV light generation controller 5 may proceed to Step S215. Here, the case where the energy of the detected EUV light 252 satisfies the EUV light energy instruction value Pte may mean that the energy of the detected EUV light 252 falls between predetermined upper and lower limits of the EUV light energy instruction value Pte. On the other hand, when the energy of the detected EUV light 252 does not satisfy the EUV light energy instruction value Pte (Step S213; NO), the EUV light generation controller 5 may again send the control voltage value calculation command to the laser controller 110 (Step S214). Thereafter, the EUV light generation controller 5 may proceed to Step S215. The laser controller 110 may again execute the control voltage value calculation routine in response to the control voltage value calculation command, to thereby recalculate the control voltage values of the high-voltage pulses S4₁ through S4ₙ to be applied to the respective optical shutters 102₁ through 102ₙ. The recalculated control voltage values of the high-voltage pulses S4₁ through S4ₙ may be reflected on the currently executed optical shutter switching routine.

In Step S215, the EUV light generation controller 5 may determine whether or not it has received a burst pause signal from the exposure apparatus controller 61 for requesting the burst output of the EUV light 252 to be paused (Step S215). When the burst pause request has not been received (Step S215; NO), the EUV light generation controller 5 may return to Step S206 of FIG. 22 and repeat the subsequent steps.

On the other hand, when the burst pause signal has been received (Step S215; YES), the EUV light generation controller 5 may, as in Step S202, output the oscillation triggers S1 to the laser controller 110 at a predetermined repetition rate to cause the master oscillators 101₁ through 101ₙ to oscillate with predetermined pulse energy (Step S216). The laser controller 110 may output the oscillation triggers S3 to the master oscillators 101₁ through 101ₙ at a predetermined repetition rate in accordance with the oscillation triggers S1. Further, the EUV light generation controller 5 may, as in Step S203, control the laser controller 110 to close the optical shutters 102₁ through 102ₙ (Step S217). With this, the pulse laser beams L1₁ through L1ₙ, may be blocked by respective the optical shutters 102₁ through 102ₙ. At this point, each of the amplifiers 120₁ through 120ₙ may be brought into an unoperated state. Here, Step S217 may be carried out prior to Step S216 or simultaneously with Step S216.

Subsequently, the EUV light generation controller 5 may determine whether or not it has been notified of the end of the exposure from the exposure apparatus controller 61 (Step S218). When the end of the exposure has not been notified (Step S218; NO), the EUV light generation controller 5 may return to Step S205 of FIG. 22 and repeat the subsequent steps. On the other hand, when the end of the exposure has been notified (Step S218; YES), the EUV light generation controller 5 may stop outputting the oscillation triggers S1 to the laser controller 110 (Step S219). Further, the EUV light generation controller 5 may stop sending the target output signal to the target controller 260 (Step S220). With this, the output of the pulse laser beams L1₁ through L1ₙ from the respective master oscillators 101₁ through 101ₙ and the output of the target 27 from the target generator 26 may be stopped. Thereafter, the EUV light generation controller 5 may terminate this operation.

### 7. Supplementary Descriptions

### 7.1 Variation of Optical Shutter

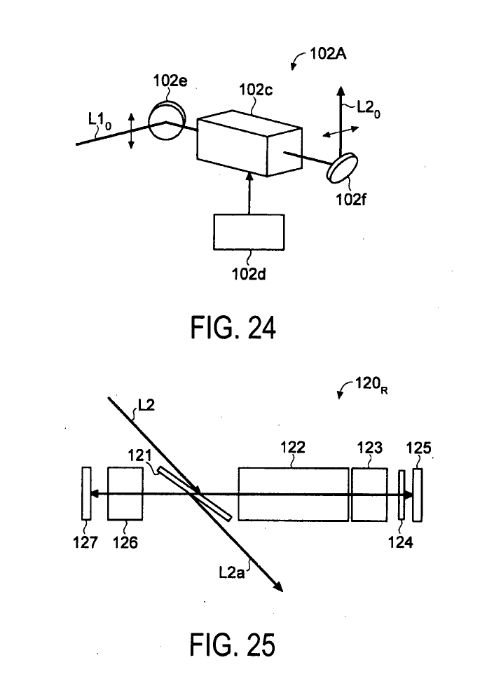

FIG. 24 shows a variation of the above-described optical shutter 102. As illustrated in FIG. 24, an optical shutter 102A may include, for example, two reflective polarizers 102e and 102f and the Pockels cell 102c. Even with such reflective polarizers 102e and 102f, functionality similar to that of the optical shutter 102 may be achieved by operating the optical shutter 102A similarly to the optical shutter 102 shown in FIG. 3. Further, when the reflective polarizers 102e and 102f are used, the optical shutter 102A which is more resistive to a heat load may be obtained, compared to the case where the transmissive polarizers 102a and 102b are used. The reflective polarizers 102e and 102f may each be an Absorbing Thin-Film Reflector (ATFR), for example. Here, being resistive to a head load may mean that the optical shutter is less likely to be heated, or can operate more stably against a rise in temperature.

### 7.2 Regenerative Amplifier

The regenerative amplifier 120_{R} will now be described in detail. FIG. 25 schematically illustrates the configuration of the regenerative amplifier 120_{R}. The regenerative amplifier 120_{R} may include a polarization beam splitter 121, a CO₂ gas amplification part 122, Pockels cells 123 and 126, a quarter-wave plate 124, and resonator mirrors 125 and 127.

The polarization beam splitter 121 may be a thin-film polarizer, for example. The polarization beam splitter 121 may reflect the S-polarization component of a laser beam incident thereon and transmit the P-polarization component thereof. The pulse laser beam L2 which has entered the regenerative amplifier 120_{R} may first be incident on the polarization beam splitter 121 mostly as the S-polarization component and be reflected thereby. With this, the pulse laser beam L2 may be introduced into a resonator formed by the resonator mirrors 125 and 127. The pulse laser beam L2 taken into the resonator may be amplified as it passes through the CO₂ gas amplification part 122. Then, the pulse laser beam L2 may pass through the Pockels cell 123, to which a voltage is not applied. Further, the pulse laser beam L2 may be transmitted through the quarter-wave plate 124, reflected by the resonator mirror 125, and again transmitted through the quarter-wave plate 124, whereby the polarization direction of the pulse laser beam L2 may be rotated by 90 degrees.

The pulse laser beam L2 may then pass through the Pockels cell 123 again, to which a voltage is not applied. At this point, a predetermined voltage may be applied to the Pockels cell 123 by a power source (not shown) after the pulse laser beam L2 passes therethrough. The Pockels cell 123, to which the predetermined voltage is applied, may give a quarter-wave phase shift to a laser beam passing therethrough. Thus, while the predetermined voltage is applied to the Pockels cell 123, the polarization direction of the pulse laser beam L2 incident on the polarization beam splitter 121 may be retained in a direction parallel to the plane of incidence, and therefore the pulse laser beam L2 may be trapped in the resonator.

Thereafter, at a timing at which the pulse laser beam L2a is to be outputted, a predetermined voltage may be applied to the Pockels cell 126 by a power source (not shown). The pulse laser beam L2 traveling back and forth in the resonator may be transmitted through the polarization beam splitter 121 and then be subjected to a quarter-wave phase shift when passing through the Pockels cell 126. Then, the pulse laser beam L2 may be reflected by the resonator mirror 127 and pass through the Pockets cell 126 again, to thereby be converted into a linearly-polarized laser beam that may be incident on the polarization beam splitter 121 mostly as the S-polarization component. The pulse laser beam L2 incident on the polarization beam splitter 121 mostly as S-polarization component may be reflected by the polarization beam splitter 121, and be outputted from the regenerative amplifier 120_{R} as the pulse laser beam L2a. Here, controlling the duration for which the voltage is applied to the Pockels cell 126 may allow the pulse width of the pulse laser beam L2 (or L2a) to be controlled.

### 7.3 Beam Path Adjusting Unit

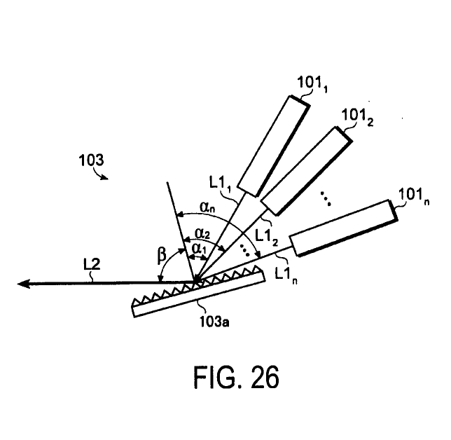

FIG. 26 shows an example of the beam path adjusting unit 103 and an arrangement of the master oscillators 101₁ through 101ₙ with respect to the beam path adjusting unit 103. In FIG. 26, the optical shutters 102₁ through 102ₙ are not depicted.

As illustrated in FIG. 26, the beam path adjusting unit 103 may include a reflective grating 103a. The master oscillators 101₁ through 101ₙ may, for example, be positioned with respect to the grating 103a such that rays diffracted at the same order (e.g., −1st order) of the respective laser beams L1₁ through L1ₙ from the respective master oscillators 101₁ through 101ₙ are outputted from the grating 103a at the same angle in the same direction. The master oscillators 101₁ through 101ₙ may preferably be positioned with respect to the grating 103a so as to satisfy Expression (1) below. In Expression (1), N is the number of grooves per unit length, λ₁ through λₙ are central wavelengths of the respective pulse laser beams L1₁ through L1ₙ, β is a diffraction angle, and α₁ through αₙ are incident angles of the respective pulse laser beams L1₁ through L1ₙ.

$$Nm {λ}_{1} = sin β \pm sin {α}_{1} \\ Nm {λ}_{2} = sin β \pm sin {α}_{2} \\ … \\ Nm {λ}_{n} = sin β \pm sin {α}_{n} \qquad ( 1 )$$

By positioning the master oscillators 101₁ through 101ₙ with respect to the reflective grating 103a in the above-described manner, the beam paths of the pulse laser beams L1₁ through L1ₙ may be made to coincide with one another with ease using a compact optical element (i.e., grating 103a). Here, the reflective grating 103a has been used in this example, but a transmissive grating may be used instead.

### 7.4 Seed Laser Device Including Multi-Longitudinal Mode Master Oscillator and Spectroscope

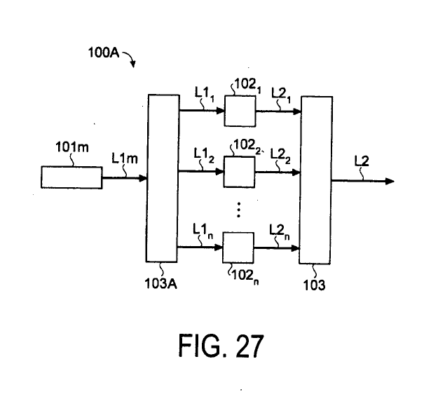

In one or more of the embodiments, when a pulse laser beam is to be subjected to the multi-line amplification, a seed laser device 100A that includes a multi-longitudinal mode master oscillator may be used in place of the seed laser device 100. FIG. 27 schematically illustrates the configuration of the seed laser device 100A.

As shown in FIG. 27, the seed laser device 100A may include a master oscillator 101m, a spectroscope 103A, the optical shutters 102₁ through 102ₙ, and the beam path adjusting unit 103. The optical shutters 102₁ through 102ₙ and the beam path adjusting unit 103 may be similar to the optical shutters 102₁ through 102ₙ and the beam path adjusting unit 103 shown in FIG. 2.

The reflective grating 103a shown in FIG. 26 may be used as the spectroscope 103A. However, this disclosure is not limited thereto, and a transmissive grating or the like may be used instead. Further, when the grating 103a is used as the spectroscope 103A, the spectroscope 103A may further include an optical system, such as a mirror, for adjusting the beam paths (output directions) of the diffracted rays.

The master oscillator 101m may, for example, output a multi-longitudinal mode laser beam L1m at wavelengths contained in at least two of the amplification lines of the amplifier 120. The spectroscope 103A may split the pulse laser beam L1m into the pulse laser beams L₁ through L1ₙ for respective longitudinal modes (wavelengths). The optical shutters 102₁ through 102ₙ may be provided in beam paths of the respective pulse laser beams L1₁ through L1ₙ which have been split by and outputted from the spectroscope 103A. The pulse laser beams L2₁ through L2ₙ transmitted through the respective optical shutters 102₁ through 102ₙ may then enter the beam path adjusting unit 103. The beam path adjusting unit 103 may make the beam paths of the pulse laser beams L2₁ through L2ₙ substantially coincide with one another and be outputted as the pulse laser beam L2.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular embodiments may be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus, comprising:
a plurality of master oscillators each configured to output a pulse laser beam at a different wavelength;
at least one amplifier for amplifying the pulse laser beams;
an optical shutter provided in a beam path of at least one of the pulse laser beams, the optical shutter being configured to adjust a transmittance of a pulse laser beam passing therethrough in accordance with a voltage applied thereto;
a power source for applying the voltage to the optical shutter;
a beam path adjusting unit provided in a beam path between the optical shutter and the amplifier for making beam paths of the pulse laser beams coincide with one another; and
a controller configured to control the voltage to be applied to the optical shutter by the power source on a pulse-to-pulse basis for the pulse laser beam.

2. The laser apparatus according to claim 1, wherein the controller is configured to control the voltage applied to the optical shutter such that energy of the pulse laser beam transmitted through the optical shutter is at a predetermined energy level.

3. The laser apparatus according to claim 1, wherein each of the master oscillators is at least one of a semiconductor laser and a solid-state laser.

4. The laser apparatus according to claim 3, wherein a plurality of optical shutters are provided in beam paths of the respective pulse laser beams from the master oscillators.

5. The laser apparatus according to claim 4, wherein the at least one amplifier includes a carbon dioxide gas as a gain medium.

6. The laser apparatus according to claim 5, wherein the at least one amplifier includes a regenerative amplifier.

7. The laser apparatus according to claim 4, wherein
the controller is configured to:
calculate a transmittance required for at least one of the optical shutters from energy required for an amplified pulse laser beam amplified by the amplifier; and
adjust the voltage to be applied to the optical shutter based on the calculated transmittance.

8. The laser apparatus according to claim 7, wherein the controller is configured to receive a value of the energy required for the amplified pulse laser beam from an external device.

9. The laser apparatus according to claim 1, wherein the optical shutter includes:
an electro-optic device;
a first optical filter provided at an input end of the electro-optic device; and
a second optical filter provided at an output end of the electro-optic device.

10. The laser apparatus according to claim 9, wherein the electro-optic device is a Pockels cell.

11. The laser apparatus according to claim 10, wherein the first and second optical filters each include at least one polarizer.

12. A method for generating a laser beam in a laser apparatus that includes an amplifier containing a laser gas as a gain medium, at least two master oscillators each configured to output a pulse laser beam at a different wavelength that can be amplified in the amplifier, and at least two optical shutters provided in beam paths of the respective pulse laser beams between the master oscillators and the amplifier, the method comprising:
adjusting a transmittance of at least one of the two optical shutters on a pulse-to-pulse basis for the pulse laser beams from the master oscillators.

13. An extreme ultraviolet light generation system, comprising:
the laser apparatus of claim 1;
a chamber;
a target supply unit configured to output a target material toward a predetermined region inside the chamber;
a focusing optical element for focusing a pulse laser beam from the laser apparatus in the predetermined region inside the chamber;
a target detector for detecting the target material passing through a predetermined position; and
a control unit configured to output a signal to cause the laser apparatus to output the pulse laser beam based on a target detection signal from the target detector.

14. An extreme ultraviolet light generation system, comprising: the laser apparatus of claim 8;
a chamber;
a target supply unit configured to output a target material toward a predetermined region inside the chamber;
a focusing optical element for focusing a pulse laser beam from the laser apparatus in the predetermined region inside the chamber;
a target detector for detecting the target material passing through a predetermined position;
an extreme ultraviolet light energy detector for detecting energy of extreme ultraviolet light emitted from plasma generated when the target material is irradiated by the pulse laser beam in the predetermined region; and
a control unit configured to output a signal to the controller to cause the laser apparatus to output the pulse laser beam based on a target detection signal from the target detector and to output a value of the energy required for the amplified pulse laser beam to the controller based on an extreme ultraviolet light energy detection value from the extreme ultraviolet light energy detector.
